(19) United States
(12) Patent Application Publication
(10) Pub. No.: US 2007/0296654 A1
(43) Pub. Date: Dec. 27, 2007

(54) Image Processing Device of a Liquid Crystal Display

(76) Inventor: Cheng-Su Huang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/425,715

(22) Filed: Jun. 22, 2006

(51) Int. Cl. G09G 3/36

(52) U.S. Cl. 345/87

(57) ABSTRACT

An image processing device of a liquid crystal display device includes a digital signal reception interface, a digital signal output interface, a plurality of image signal reception interfaces, an image processing unit coupled to an output terminal of the digital signal reception interface and the image processing unit, a switch unit coupled to the output terminal of the digital signal reception interface, an input terminal of the digital signal output interface, and the image processing unit, for transmitting signals outputted from the output terminal of the digital signal reception interface or a processed result of the image processing unit to the input terminal of the digital signal output interface according to a control signal, and a control module coupled to the image processing unit and the switch unit, for outputting the control signal.

### BACKGROUND OF THE INVENTION

1. Field of the Invention

The present invention provides an image processing device, and more particularly, an image processing device having DVI interfaces and providing TV box functions.

2. Description of the Prior Art

Compared to a cathode ray tube (CRT) monitor, a liquid crystal display (LCD) monitor has incomparable advantages, such as low power consumption, no radiation, small volume, etc., so that the LCD monitor has become a substitute for the CRT monitor. Generally, in a computer system, interfaces for transmitting signals between a graphics card and the LCD are DVI (digital visual interface) and D-sub. The D-sub interface is utilized for transmitting analog signals. Since a CRT monitor uses analog signals, a graphics card connecting to the CRT monitor must include a digital to analog (D/A) converter for transforming digital signals into analog signals for the CRT monitor. However, the LCD monitor uses digital signals to display images pixel by pixel, so that a DVI interface is provided for transmitting digital signals of the graphics card to the LCD monitor.

In order to enhance multimedia functions of a computer system, a TV box or TV card can be installed in the computer system for showing TV programs on a screen of the computer system. However, the prior art TV box exchanges signals with the screen through a D-sub interface because it is difficult to design a TV box using a DVI interface. Main components of an LCD monitor are an LCD panel and a controller. Between the controller and the LCD panel, the prior art provides two standard interfaces. As shown in FIG. 1, one is a parallel serial interface, such as transistor-transistor logic (TTL) and low voltage transistor-transistor logic (LVTTL) interfaces, which transmits display data and a clock signal through separate routes. The other, as shown in FIG. 2, is a differential serial interface, such as low voltage differential signal (LVDS) interface. In the differential serial interface, display data and a clock signal are transmitted to differential pairs through a plurality of loops, so that low voltage differential signals are not corresponding to specified data channel or types, and do not include R, G, B (red, blue, green) differential pairs as shown in FIG. 3.

Therefore, the parallel and differential serial interfaces transmit signals through different ways, causing a TV box using a DVI interface cannot be easily implemented.

### SUMMARY OF THE INVENTION

It is therefore a primary objective of the claimed invention to provide an image processing device of a liquid crystal display device.

According to the claimed invention, an image processing device of a liquid crystal display device includes a digital signal reception interface having an input terminal and an output terminal, for receiving digital parallel serial signals from the input terminal, transforming the digital parallel serial signals into digital parallel serial signals, and outputting the digital parallel serial signals from the output terminal, a digital signal output interface having an input terminal and an output terminal, for receiving digital parallel serial signals from the input terminal, transforming the digital parallel serial signals into digital parallel serial signals, and outputting the digital parallel serial signals from the output terminal, a plurality of image signal reception interfaces for receiving image signals, an image processing unit coupled to the output terminal of the digital signal reception interface and the image processing unit, for processing signals outputted from the output terminal of the digital signal reception interface or signals received by the plurality of the image signal reception interfaces according to a first control signal, a switch unit coupled to the output terminal of the digital signal reception interface, the input terminal of the digital signal output interface, and the image processing unit, for transmitting signals outputted from the output terminal of the digital signal reception interface or a processed result of the image processing unit to the input terminal of the digital signal output interface according to a second control signal, and a control module coupled to the image processing unit and the switch unit, for outputting the first control signal and the second control signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a transistor-transistor logic interface.

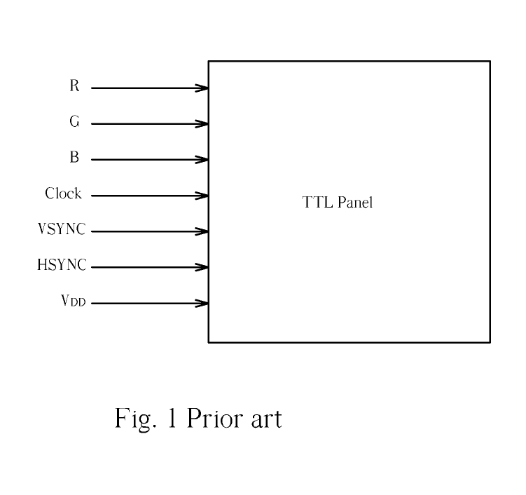

FIG. 2 illustrates a schematic diagram of a low voltage differential signal interface.

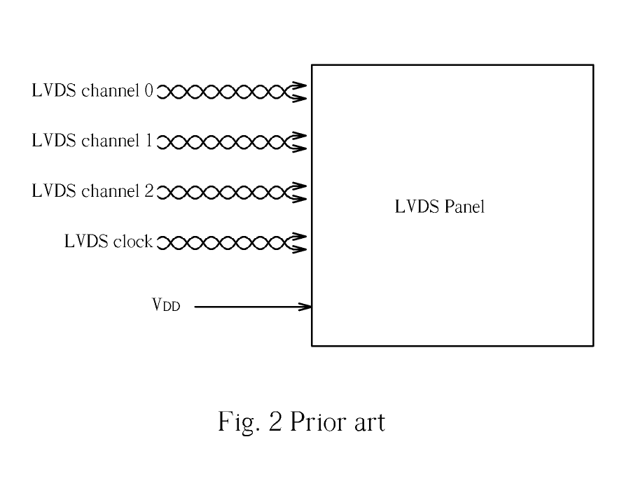

FIG. 3 illustrates a schematic diagram of low voltage differential signals.

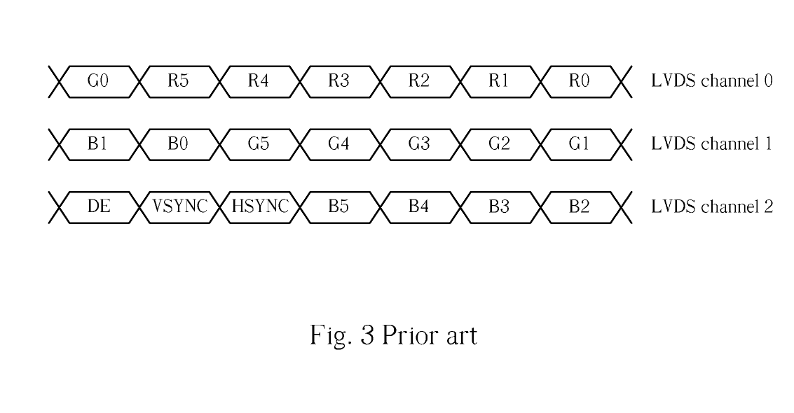

FIG. 4 illustrates a schematic diagram of an image processing device of an LCD in accordance with an embodiment of the present invention.

FIG. 5 illustrates a schematic diagram of signal routes of the image processing device shown in FIG. 4 when being operated in a first mode.

FIG. 6 illustrates a schematic diagram of signal routes of the image processing device shown in FIG. 4 when being operated in a second mode.

FIG. 7 illustrates a schematic diagram of signal routes of the image processing device shown in FIG. 4 when being operated in a third mode.

FIG. 8 illustrates a schematic diagram of signal routes of the image processing device shown in FIG. 4 when being operated in a fourth mode.

### DETAILED DESCRIPTION

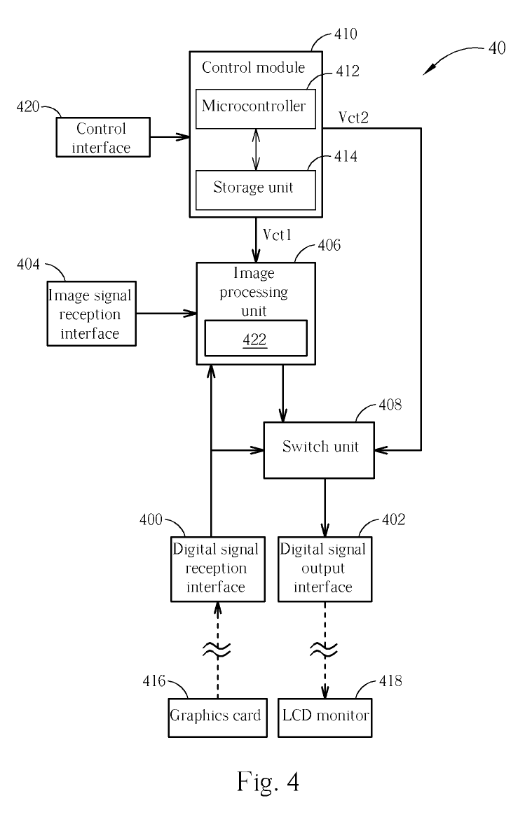

Please refer to FIG. 4, which illustrates a schematic diagram of an image processing device 40 of an LCD in accordance with an embodiment of the present invention. The image processing device 40 includes a digital signal reception interface 400, a digital signal output interface 402, an image signal reception interface 404, an image processing unit 406, a switch unit 408, and a control module 410. The digital signal reception interface 400 receives digital parallel serial signals (ex. LVDS) from a graphics card 416, transforms the received digital parallel serial signals into digital parallel serial signals (ex. TTL), and outputs the digital parallel serial signals to the image processing unit 406 and the switch unit 408. The digital signal output interface 402 can receive digital parallel serial signals outputted from the switch unit 408, and transforms the digital parallel serial signals into digital parallel serial signals for an LCD monitor 418. Preferably, the digital signal reception interface 400 and the digital signal output interface 402 conform to the DVI standard. The image signal reception interface 404 can be reception terminals of coaxial cable, color difference signals, composite signals, etc., utilized for receiving image signals from broadcasting TV systems, DVD players, etc. According to a control signal Vct1, the image processing unit 406 can process signals outputted form the digital signal reception interface 400 or signals received by the image signal reception interface 404. Preferably, the image processing unit 406 includes a picture processing unit 422, for simultaneously outputting images of the graphics card 416 and the image signal reception interface 404 by picture-in-picture (PIP) or picture-on-picture (POP). According to a control signal Vct2, the switch unit 408 transmits signals outputted from the digital signal reception interface 400 or a processed result of the image processing unit 406 to the digital signal output interface 402. The control module 410 includes a microcontroller 412 and a storage unit 414, and receives user commands through a control interface 420, such as an infrared remote control system. According to the user commands, the microcontroller 412 performs program code stored in the storage unit 414 to control operations of the image processing unit 406 and the switch unit 408.

Therefore, the image processing device 40 receives signals of the graphics card 416 through the digital signal reception interface 400, and receives image signals of electronic devices through the image signal reception interface 404. Then, the control module 410 controls the image processing unit 406 and the switch unit 408 to output signals the LCD monitor 418.

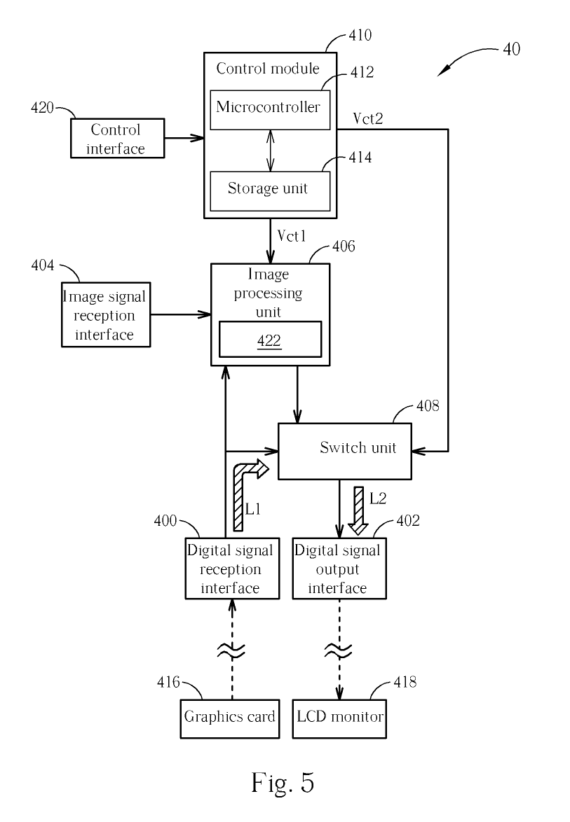

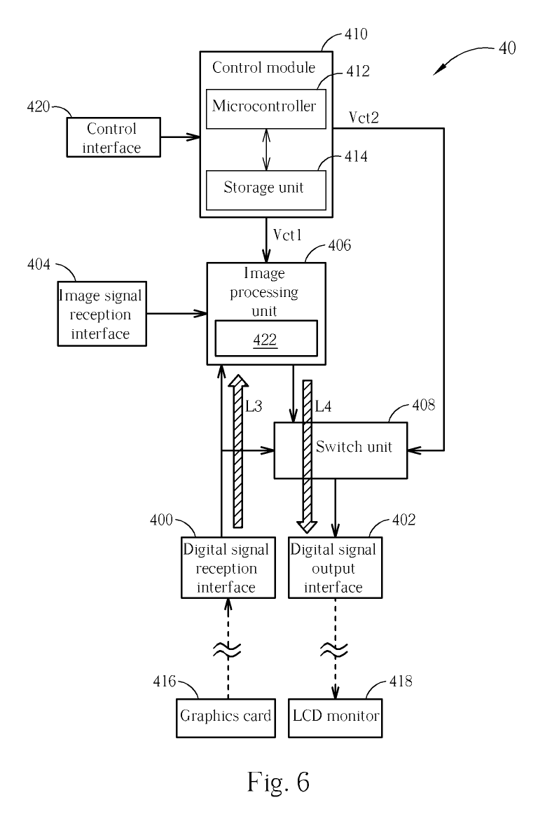

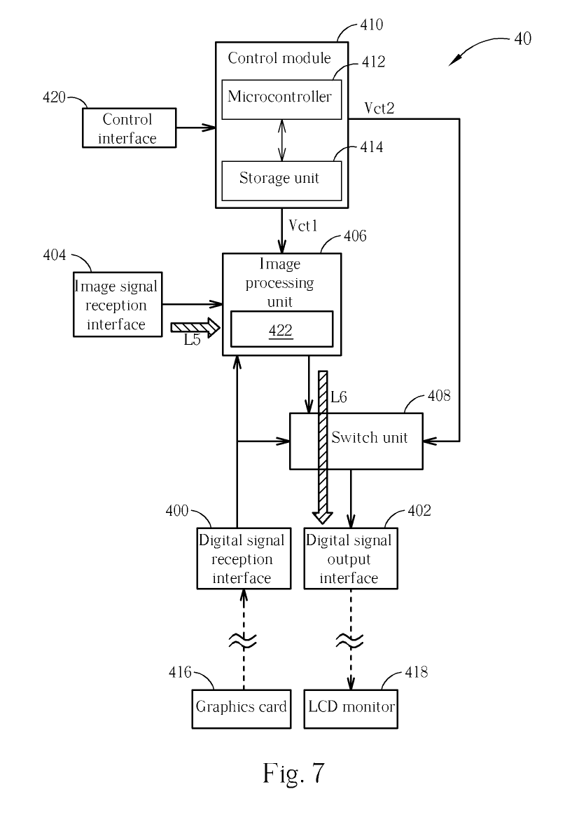

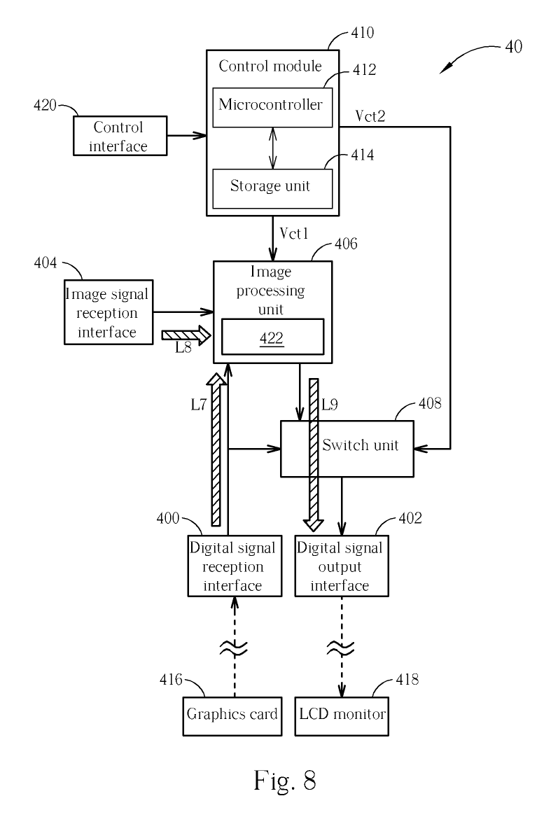

As to operations of the image processing device 40, please refer to FIG. 5 to FIG. 8, which illustrate schematic diagrams of signals routes in the image processing device 40 when being operated in a first, second, third, and fourth modes. The present invention can comply the program code stored in the storage unit 414 to operate the image processing device 40 in the first to fourth modes. As shown in FIG. 5, in the first mode, the image processing device 40 is turned off or in a sleep state, and the image processing unit 406 does not work. Then, the control module 410 controls the switch unit 408 to transmit signals received by the digital signal reception interface 400 to the input terminal of the digital signal output interface 402. Therefore, along loops L1 and L2, signals received by the digital signal reception interface 400 are transmitted through the digital signal output interface 402 to the LCD monitor 418. As shown in FIG. 6, when the image processing device 40 is operated in the second mode, the image processing unit 406 only processes signals outputted from the graphics card 416 to enhance image quality or adjust display effects. In this mode, the image processing unit 406 receives signals from the digital signal reception interface 400, and transmits processed results to the digital signal output interface 402 through the switch unit 408. In other words, when the image processing device 40 is operated in the second mode, signals received by the digital signal reception interface 400 are transmitted to the image processing unit 406 along a loop L3. Then, along a loop L4, processed results of the image processing unit 406 are transmitted through the digital signal output interface 402 to the LCD monitor 418. As shown in FIG. 7, when the image processing device 40 is operated in the third mode, the image processing unit 406 only processes signals received by the image signal reception interface 404 to decode TV or DVD signals. In this mode, the image processing unit 406 receives signals received by the image signal reception interface 404, and transmits processed results to the digital signal output interface 402 through the switch unit 408. In other words, when the image processing device 40 is operated in the third mode, signals received by the image signal reception interface 404 are transmitted to the image processing unit 406 along a loop L5, and processed results of the image processing unit 406 are transmitted through the digital signal output interface 402 to the LCD monitor 418 along a loop L6. As shown in FIG. 8, when the image processing device 40 is operated in the fourth mode, the image processing unit 406 simultaneously displays signals outputted from the graphics card 416 and received by the image signal reception interface 404 with the picture processing unit 422. In this mode, the image processing unit 406 receives signals received by the image signal reception interface 404 and the digital signal reception interface 400, and transmits processed results through the switch unit 408 to the digital signal output interface 402. In other words, when the image processing device 40 is operated in the fourth mode, signals received by the digital signal reception interface 400 and the image signal reception interface 404 are transmitted to the image processing unit 406 along loops L7 and L8, and processed results of the image processing unit 406 are transmitted to the digital signal output interface 402 along the loop L9, so that the LCD monitor 418 can display images by PIP or POP.

In summary, the present invention image processing device 40 can provide a TV box or TV card having DVI interfaces.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing device of a liquid crystal display device comprising:
a digital signal reception interface having an input terminal and an output terminal, for receiving digital parallel serial signals from the input terminal, transforming the digital parallel serial signals into digital parallel serial signals, and outputting the digital parallel serial signals from the output terminal;
a digital signal output interface having an input terminal and an output terminal, for receiving digital parallel serial signals from the input terminal, transforming the digital parallel serial signals into digital parallel serial signals, and outputting the digital parallel serial signals from the output terminal;
a plurality of image signal reception interfaces for receiving image signals;
an image processing unit coupled to the output terminal of the digital signal reception interface and the image processing unit, for processing signals outputted from the output terminal of the digital signal reception interface or signals received by the plurality of the image signal reception interfaces according to a first control signal;
a switch unit coupled to the output terminal of the digital signal reception interface, the input terminal of the digital signal output interface, and the image processing unit, for transmitting signals outputted from the output terminal of the digital signal reception interface or a processed result of the image processing unit to the input terminal of the digital signal output interface according to a second control signal; and
a control module coupled to the image processing unit and the switch unit, for outputting the first control signal and the second control signal.

2. The image processing device of claim 1, wherein the digital signal reception interface and the digital signal output interface conform to a standard of a digital visual interface.

3. The image processing device of claim 1, wherein an image signal reception interface of the plurality of the image signal reception interfaces is a reception terminal of coaxial cable.

4. The image processing device of claim 1, wherein an image signal reception interface of the plurality of the image signal reception interfaces is a reception terminal of color difference signals.

5. The image processing device of claim 1, wherein an image signal reception interface of the plurality of the image signal reception interfaces is a reception terminal of composite signals.

6. The image processing device of claim 1, wherein an image signal reception interface of the plurality of the image signal reception interfaces is an S terminal.

7. The image processing device of claim 1 further comprising a control interface coupled to the control module, for receiving signals from a user.

8. The image processing device of claim 7, wherein the control interface is an infrared remote control system.

9. The image processing device of claim 1, wherein the image processing unit comprises a picture processing unit, for simultaneously outputting processed results of signals outputted from the output terminal of the digital signal reception interface and signals received by the plurality of the image signal reception interfaces to the switch unit.

10. The image processing device of claim 9, wherein the picture processing unit is a picture-in-picture processing unit.

11. The image processing device of claim 9, wherein the picture processing unit is a picture-on-picture processing unit.

12. The image processing device of claim 1, wherein the control module comprises:
a microprocessor for performing program code; and
a storage unit for storing the program code, the program code comprising:
when the image processing device is operated in a first mode, the switch unit transfers signals outputted from the output terminal of the digital signal reception interface to the input terminal of the digital signal output interface.

13. The image processing device of claim 12, wherein the program code further comprises:
when the image processing device is operated in a second mode, the image processing unit receives signals outputted from the output terminal of the digital signal reception interface, and the switch unit transfers a processed result of the image processing unit to the input terminal of the digital signal output interface.

14. The image processing device of claim 12, wherein the program code further comprises:
when the image processing device is operated in a third mode, the image processing unit receives signals received by the plurality of the image signal reception interfaces, and the switch unit transfers a processed result of the image processing unit to the input terminal of the digital signal output interface.

15. The image processing device of claim 12, wherein the program code further comprises:
when the image processing device is operated in a fourth mode, the image processing unit receives signals received by the plurality of the image signal reception interface and signals outputted from the output terminal of the digital signal reception interface, and the switch unit transfers a processed result of the image processing unit to the input terminal of the digital signal output interface.

16. The image processing device of claim 1, wherein the input terminal of the digital signal reception interface is coupled to a graphics card of a computer system.

17. The image processing device of claim 1, wherein the output terminal of the digital signal output interface is coupled to the liquid crystal display device.
